(19) United States
(12) Patent Application Publication
(10) Pub. No.: US 2012/0022883 A1
(43) Pub. Date: Jan. 26, 2012

(54) SYSTEM AND METHOD FOR DETERMINING A STATUS OF A PROPOSED TRANSACTION

(76) Inventor: James Morrison, Henderson, NV (US)

(21) Appl. No.: 13/189,185

(22) Filed: Jul. 22, 2011

Related U.S. Application Data
(60) Provisional application No. 61/366,777, filed on Jul. 22, 2010.
(60) Provisional application No. 61/492,527, filed on Jun. 2, 2011.

(51) Int. Cl. G06Q 30/00

(52) U.S. Cl. 705/1.1

(57) ABSTRACT

Embodiments of the present invention include methods, systems, apparatuses and computer program products. Aspects of the present invention can include methods, systems, apparatuses and computer program products for correlating a potential transaction with a unique identification of a mobile terminal, the potential transaction comprising a vendor and a user of the mobile terminal; determining that the mobile terminal is in a finite location of the vendor; and compensating a broker of the potential transaction. In embodiments of the present invention, the potential transaction can be related to a unique identification of the mobile terminal, which unique identification is presented by and/or induced from the mobile terminal at a vendor location by a controller and/or system of one or more preferred embodiments.

### CLAIM OF PRIORITY

The present application claims priority to U.S. provisional patent application Ser. No. 61/366,777 filed on 22 Jul. 2010 and entitled “Systems and Methods for Networked Radio Systems and Coordinated Broadcasting,” and U.S. provisional patent application Ser. No. 61/492,527 filed on 2 Jun. 2011 and entitled “System and Method for Determining a Status of a Proposed Transaction,” both of which are expressly incorporated herein by reference.

### BACKGROUND AND SUMMARY

The present invention relates generally to location services and more specifically to methods, systems and computer program products configured for determining a status of a proposed transaction between a vendor having a physical location and a user of a mobile terminal.

A method of one preferred embodiment can include correlating a potential transaction with a unique identification of a mobile terminal, the potential transaction comprising a vendor and a user of the mobile terminal; determining that the mobile terminal is in a finite location of the vendor; and compensating a broker of the potential transaction.

An apparatus of another preferred embodiment can include a controller connected to a sensor array disposable in a finite location of a vendor and further connected to a mobile terminal defining a unique identification. The controller can be adapted to associate a potential transaction with the unique identification of the mobile terminal, and further adapted to determine a presence of the mobile terminal at the finite location of the vendor in response to receipt of the communication channel signal at the sensor array from the mobile terminal. The communication channel signal can include the unique identification of the mobile terminal.

A computer program product of another preferred embodiment can include a computer readable storage medium having computer readable program code embodied therewith. The computer readable program code can include computer readable program code to correlate a potential transaction with a unique identification of a mobile terminal, wherein the potential transaction can include a vendor and a user of the mobile terminal; computer readable program code to determine that the mobile terminal is at a finite location of the vendor; and computer readable program code to compensate a broker of the potential transaction.

A method of another preferred embodiment can include receiving a signal indicating that a mobile terminal having a unique identification was presented a potential transaction; registering that the mobile terminal has been presented the potential transaction; and registering the potential transaction to a vendor having a predetermined location. The method of another preferred embodiment can further include detecting the presence of the mobile terminal at the location of the vendor; correlating the presentation of the potential transaction with the presence of the mobile terminal at the location of the vendor.

A method of another preferred embodiment can include presenting a proposed transaction between a user and a vendor on a mobile terminal of the user, the mobile terminal having a unique identification; verifying the presence of the mobile terminal at a physical location of the vendor; and receiving compensation from the vendor in response to delivering the mobile terminal to the physical location of the vendor.

Other aspects and features of the present invention are described in detail with reference to the following drawings.

### BRIEF DESCRIPTION OF THE SEVERAL VIEWS OF THE DRAWINGS

FIG. 1 is a schematic block diagram of a system or apparatus according to another preferred embodiment of the present invention.

FIG. 2 is a flowchart depicting a method according to a preferred embodiment of the present invention.

FIG. 3 is a flowchart depicting a method according to another preferred embodiment of the present invention.

FIG. 4 is a flowchart depicting a method according to another preferred embodiment of the present invention.

FIG. 5 is a flowchart depicting a method according to another preferred embodiment of the present invention.

FIG. 6 is a flowchart depicting a method according to another preferred embodiment of the present invention.

FIG. 7 is a flowchart depicting a method according to another preferred embodiment of the present invention.

FIG. 8 is a flowchart depicting a method according to another preferred embodiment of the present invention.

FIG. 9 is a flowchart depicting a method according to another preferred embodiment of the present invention.

FIG. 10 is a flowchart depicting a method according to another preferred embodiment of the present invention.

### DETAILED DESCRIPTION OF THE PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

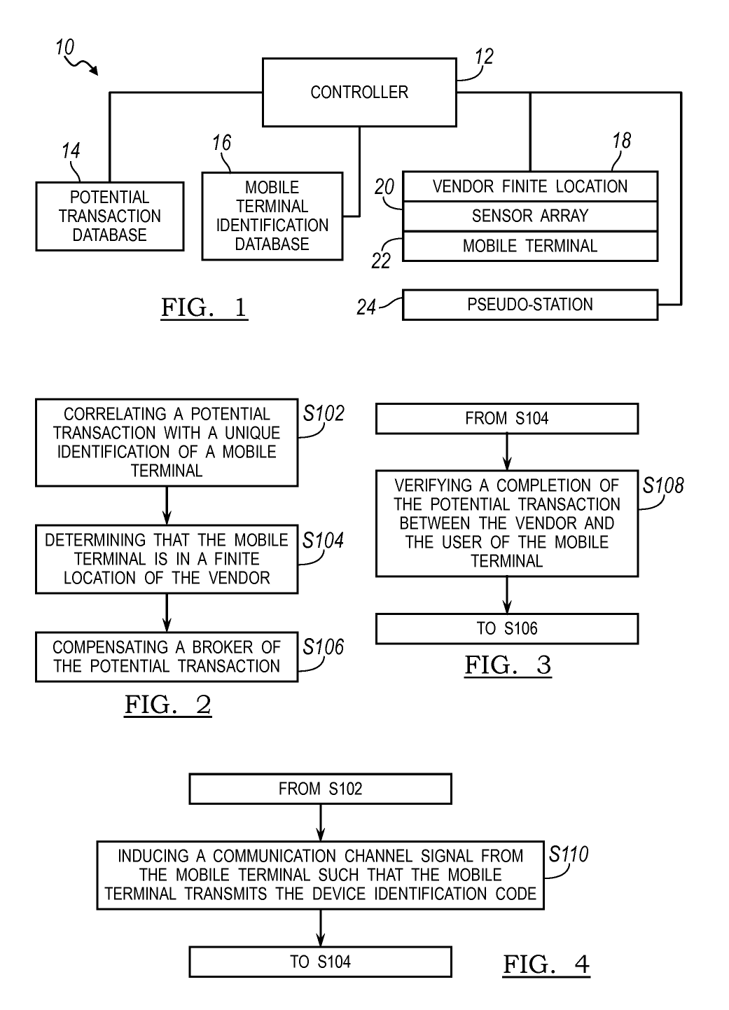

As shown in FIG. 1, a system 10 of a first preferred embodiment can include one or more apparatuses, modules or components configured for performing one or more functions described in the various methods and computer program products set forth herein. The system 10 of the first preferred embodiment can include a controller 12, which can be connected to a potential transaction database 14 and a mobile terminal identification database 16. The controller 12 of the first preferred embodiment can be configured as a single, unified computer device or a cluster or network of several computer devices and may be disposed in any suitable location or locations. Alternatively, the controller 12 can be integrated into one or more of the other structures, apparatuses and/or modules of the system 10 of the preferred embodiment, such as for example the potential transaction database 14, the mobile terminal identification database 16, a sensor array 20 or a pseudo-station 24. Alternatively, one or more aspects or functionalities of the controller 12 of the first preferred embodiment can be located on a mobile terminal 22 belonging to a user. The controller 12 of the first preferred embodiment can be configured in hardware, software, firmware or any suitable combination thereof, and may have one or more functionalities or processes that are distributed, localized or both in a fixed or dynamic configuration.

The controller 12 of the first preferred embodiment can be connected to a sensor array 20 disposable in a finite location 18 of a vendor. As used herein, the term finite location should be understood to include any indoor location, outdoor location, or combination thereof having a predetermined and finite geometrical configuration. Example finite locations can include, but are not limited to, an indoor shopping mall, an outdoor shopping mall, an indoor/outdoor shopping mall, an office building, an airport, a subway terminal, a train station, a conference center, a stadium or concert hall, a parking lot, a portion of a block, street, or intersection, as well as any suitable combination thereof. The term finite location can include any adjoining outdoor area to an indoor location, any adjoining indoor location to an outdoor location, and any doors, passages, byways or entrances/exits there between.

The sensor array 20 of the system 10 of the preferred embodiment can include one or more sensors that function to receive and/or detect a communication channel signal from the mobile terminal 22. As used herein, the term communication channel signal 22 should be understood to include any type of signal from a radio device that uniquely identifies the device to a potential network, sometimes referred to as a communication channel or as a signaling channel, depending upon the type of network under consideration. A sensor array 20 having a single sensor can be configured for determining a presence of a mobile terminal 22 within the vendor finite location 18; and a sensor array 20 having multiple sensors can further determine a location of the mobile terminal 22 within the vendor finite location 18. As an example, a sensor array 20 having four sensors can be configured for calculating a three dimensional position of the mobile terminal 22 within the vendor finite location 18. Positional calculations can include for example time of flight information indicative of a time lapse in receipt of the communication channel signal 22 and/or intensity or signal strength information indicative of a relative strength or magnitude of the communication channel signal at one or more of the sensors in the sensor array 20.

The sensor array 20 of the system 10 of the first preferred embodiment can be configured as hardware, firmware or software that is capable of receiving and/or detecting RF transmissions of one or more frequencies of communication channel signals from the mobile terminal 22. The sensor array 20 of the system 10 of the first preferred embodiment can be adapted to detect a communication channel signal transmitted by the mobile terminal 22 in the vendor finite location 18, wherein the communication channel signal can include a unique identification of the mobile terminal 22. Example unique identifications of the mobile terminal 14 can include, but are not limited to: an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal 14 in identifying itself to a communication network.

The controller 12 of the system 10 of the first preferred embodiment can be further adapted to associate a potential transaction with the unique identification of the mobile terminal 22. The potential transaction database 14 of the system 10 of the preferred embodiment functions to store, select and make available one or more potential transactions or offers that are made to one or more users of mobile terminals 22. Example potential transactions can include, but are not limited to, offers for sale of goods or services including discounts, coupons, rebates, specials, and the like, for a particular vendor having one or more particular finite locations 18. The mobile terminal identification database 16 can include unique identifiers, an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal 14 in identifying itself to a communication network. The controller 12 of the system 10 of the preferred embodiment functions to assimilate and correlate data relating to one or more potential transactions retrievable from the potential transaction database 14 with one or more mobile terminal identifications (relating to one or more unique mobile terminals 22) that have received notification of the potential transaction.

In one variation of the system 10 of the preferred embodiment, a mobile terminal 22 can have a single unique identification in the mobile terminal identification database 16, but any mobile terminal 22 can be associated with any number of potential transactions stored in the potential transaction database 14. Alternatively, a mobile terminal 22 of the system 10 of the preferred embodiment can have multiple identifiers in the mobile terminal identification database 16 (such as for example an IMEI and an IP and/or MAC address); one or more of which can be associated with any number of potential transactions stored in the potential transaction database 14.

The controller 12 of the system 10 of the first preferred embodiment can be further adapted to determine a presence of the mobile terminal 22 at the vendor finite location 18 in response to receipt of the communication channel signal at the sensor array 20. In another variation of the system 10 of the first preferred embodiment, the sensor array 20 can function to notify the controller 12 of the presence of the mobile terminal 22 by transmission of a signal including the unique identification of the mobile terminal 22, such that the controller 12 can match the unique identification to the mobile terminal identification database 16. Alternatively, the sensor array 20 can function to notify the controller 12 of the presence of the mobile terminal 22 by transmission of a second signal, such as for example an encrypted signal, having the unique identification of the mobile terminal 22 for processing by the controller 12. In yet another alternative, portions of the functionality of the controller 12 can be integrated into the sensor array 20 and connected to the mobile terminal identification database 16 for direct processing of the identify of the mobile terminal 22 in response to receipt of the communication channel signal at the sensor array 20.

In another variation of the system 10 of the preferred embodiment, the controller 12 can be connected to a pseudo-station 24 disposable in the vendor finite location 18. The pseudo-station 24 of the system 10 of the preferred embodiment can be adapted to transmit a control channel signal in order to induce the communication channel signal from the mobile terminal 22, which in turn identifies the mobile terminal 22 to the sensor array 20 and the controller 12. The pseudo-station 24 of the system 10 of the first preferred embodiment functions as at least one portion of a base station of the type used in mobile communications over radio frequencies, i.e. mobile telephony networks such as GSM or CDMA networks, WiFi networks, WiMax networks, LTE networks, Bluetooth networks, and the like. Alternatively, the pseudo-station 24 of the system 10 of the first preferred embodiment can function only to interrogate and initiate communications with a mobile terminal 22 on a control channel.

In another variation of the system 10 of the preferred embodiment, the pseudo-station 24 can be configured to transmit a control channel signal at a predetermined frequency for a predetermined duration, thereby inducing the mobile terminal 22 to identify itself via a communication channel signal, which can be detected by the sensor array 20. The predetermined frequency at which the pseudo-station 24 transmits the control channel signal can include a frequency range correlated to a selected type of mobile terminal 22. As a non-limiting example, the pseudo-station 24 of the preferred embodiment can transmit a control channel signal on or in a frequency range dedicated to cellular phone mobile terminals (including portions of spectrum dedicated to different types of network protocols such as CDMA and GSM), WiFi enabled mobile terminals, WiMax enabled mobile terminals, LTE enabled mobile terminals, Bluetooth enabled mobile terminals, and the like. Alternatively, the pseudo-station 24 of the system 10 of the first preferred embodiment can be further adapted to transmit the control channel signal on one or more channels within the frequency range. Within a predetermined portion of the RF spectrum that is allocated for a particular type of mobile terminal 22 communication network, there can be multiple channels. Accordingly, the pseudo-station 24 of the system 10 of the first preferred embodiment can be configured to transmit the control channel signal on one, multiple, or all channels within a particular band of frequencies in order to induce communication with various types of mobile terminals 22.

In another variation of the system 10 of the first preferred embodiment, the pseudo-station 24 can be configured to transmit the control channel signal for a predetermined duration. In one example configuration, the predetermined duration can range between 1 microsecond and 10 seconds. The predetermined duration can be fixed or dynamic, or it can vary between predetermined frequencies and/or channels within the predetermined frequencies. Alternatively, the predetermined duration can be determined, either fixedly or dynamically, as inversely proportional to an activity level within the vendor finite location 18. That is, a shorter predetermined duration can correspond with a higher activity level within the vendor finite location 18. As an example, for a vendor finite location 18 having relatively few users and/or relatively stationary of mobile terminals 22, such as a movie theatre, the predetermined duration can be longer. Conversely, for a vendor finite location 18 having relatively many users and/or mobile users of mobile terminals 22, such as a subway entrance, the predetermined duration can be shorter. A vendor finite location 18 can also have different time periods such as rush hour, holiday shopping/travel, seasons, or other factors that can result in an increase or decrease in the predetermined duration for which the pseudo-station 24 transmits the control channel signal.

In another variation of the system 10 of the first preferred embodiment, the pseudo-station 24 and the sensor of the sensor array 20 can be configured as an integrated cellular base station, such that the pseudo-station 24 and the sensor can function in a unified manner to transmit a control channel signal and to receive one or more communication channel signals. Furthermore, the integrated pseudo-station 24 and sensor can be configured for forward transmission of communication channel signals (not shown) to the one or more mobile terminals 22 in its network. The pseudo-station 24 and sensor of the present variation of the first preferred embodiment can be configured as any one of a microcell, picocell or femtocell, depending upon the application requirements and the configuration of the vendor finite location 18.

As shown in FIG. 2, a method according to a second preferred embodiment can include block S102, which recites correlating a potential transaction with a unique identification of a mobile terminal. The potential transaction can include for example a contemplated or proposed transaction between a vendor of goods or services and a user of the mobile terminal. The potential transaction can arise at the mobile terminal in any number of ways, including for example: as the result of an Internet search conducted on the mobile terminal, the browsing of a webpage associated with the vendor at the mobile terminal, the use of an application associated with the mobile terminal, the receipt of a coupon from a coupon service at the mobile terminal, the scanning of a barcode by the mobile terminal, receipt of an SMS or MMS message at the mobile terminal, receipt of an email message at the mobile terminal, or receipt of a voice or other data message at the mobile terminal.

Block S102 of the method of the second preferred embodiment functions to associate a particular mobile terminal with a particular proposed transaction, and can further function to associate one or more mobile terminals each with a set or group of proposed transactions based upon a behavior of the user of the mobile terminal. For example, if the user of the mobile terminal is repeatedly searching for a particular good or service, then block S102 can function to associate multiple potential transactions from multiple vendors with the mobile terminal. The mobile terminal can be identified by any suitable address or code including, but not limited to: an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network.

Block S104 of the method of the second preferred embodiment recites determining that the mobile terminal is a finite location of the vendor. Block S104 functions to confirm that the user of the mobile terminal with which the potential transaction is correlated has in fact arrived at and/or entered a physical establishment or location of the vendor offering the goods or services of the potential transaction. In one variation of the method of the second preferred embodiment, the finite location of the vendor can be within a larger finite location, such as for example a shopping mall or department store. Alternatively, the finite location of the vendor can include an aisle or portion of an aisle within a larger establishment, such as a shopping mall, department store, grocery store, so-called big box store, or any other establishment within which goods or services of multiple vendors are offered.

Block S106 of the method of the second preferred embodiment recites compensating a broker of the potential transaction. The broker of the potential transaction can be a third party that is unrelated to the vendor or the user of the mobile terminal, such as for example: an Internet search engine service, a mobile terminal application service, an electronic coupon service, an Internet auction service, a barcode service, an SMS sales service, an MMS sales service, an electronic mail sales service, an Internet sales service or any combination thereof. Alternatively, the broker of the potential transaction can be an agent of the vendor, representative of the vendor, affiliate of the vendor, employee of the vendor, partner of the vendor, subsidiary of the vendor, the vendor itself, or any combination thereof. The broker can be a single entity or individual or a combination of multiple entities or individuals, and can be compensated by the vendor, the user of the mobile terminal, or any suitable combination thereof.

As shown in FIG. 3, another variation of the method of the second preferred embodiment can include block S108, which recites verifying a completion of the potential transaction between the vendor and the user of the mobile terminal. In one alternative, the verification of the completion of the potential transaction between the vendor and the user of the mobile terminal can be completed as a precondition for compensating the broker of the potential transaction. In another alternative, the verification of the completion of the potential transaction can function for information or analytical purposes for one or more of the vendor or the broker in order to assess the viability and success of the presentation and delivery of the potential transaction to the mobile terminal of the user.

In another variation of the method of the preferred embodiment, the unique identification of the mobile terminal can include a device identification code. Suitable device identification codes can include: an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network. Suitable communication networks can include cellular phone mobile networks (including CDMA and GSM networks), WiFi networks, WiMax networks, LTE networks, Bluetooth networks, and any other RF wireless network to which a mobile terminal is connectable. A mobile terminal can have more than one unique identifier. For example, a typical smartphone can have both an IMEI and a MAC address and may be configured for connecting to the Internet via a cellular network and/or a WiFi network, in which case both unique identifiers can be associated with a single mobile terminal and therefore a single user of that mobile terminal. Accordingly, a user of the mobile terminal can view a potential transaction (i.e., conduct an Internet search) using a WiFi connected mobile terminal, and then arrive at a vendor location and be identified in response to an IMEI or other non-WiFi identifier. Suitable means for categorizing and correlating multiple unique identifiers to a single mobile terminal can be accomplished for example by a controller or a mobile terminal identification database of the type described herein.

In another variation of the method of the second preferred embodiment, block S104 can further include receiving a communication channel signal including the device identification code at the finite location of the vendor. As noted above, the device identification code can include, but are not limited to: an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network. The communication channel signal can be transmitted by the mobile terminal at the finite location of the vendor on its own accord, or in response to an external stimulus, such as the receipt of a signal by the mobile terminal at the finite location of the vendor. In one alternative, receiving a communication channel signal can include receiving, at a sensor array of the type described above, the communication channel signal.

As shown in FIG. 4, another variation of the method of the second preferred embodiment can include block S110, which recites inducing the communication channel signal from the mobile terminal such that the mobile terminal transmits the device identification code. In one alternative, inducing a communication channel signal can include transmitting a control channel signal within the finite location of the vendor. Transmitting a control channel signal within the finite location can include transmitting a control channel signal from a pseudo-station within the finite location.

In another alternative of the method of the second preferred embodiment, block S106, which recites compensating the broker of the potential transaction, can include compensating the broker in response to a completed transaction between the vendor and the user of the mobile terminal. In such a manner, the broker of the potential transaction can be compensated in response to an exchange of value between the vendor and the user of the mobile terminal. Broker compensation can be derived from the vendor, the user of the mobile terminal, or an unrelated party. Alternatively, the broker compensation can be derived from the vendor in response to the vendor's receipt of compensation from the user of the mobile terminal, and the broker's compensation can be derived as a commission or percentage of completed transactions.

In another alternative of the method of the second preferred embodiment, block S106, which recites compensating the broker of the potential transaction, can include compensating the broker in response to a number of mobile terminals detected in the location of the vendor. In this alternative to the method of the second preferred embodiment, the broker can be compensated by driving traffic (users of mobile terminals) to the finite location of the vendor. The broker compensation can be derived on a fee-per-user basis measured over a time interval, or a fee-per-user basis measured for a particular event such as a sale or special offer. Additionally, the broker compensation can be a combination of a fee-per-user amount combined with a fee-per-completed transaction of the type described above, such that a broker can realize additional compensation for driving traffic to the vendor that results in actual revenues to the vendor.

In another alternative of the method of the second preferred embodiment, the potential transaction can be initiated by one of the user, the vendor, or the broker. A user-initiated potential transaction can include any number of events such as an Internet search for a particular vendor or class of goods or services, while a vendor-initiated potential transaction can include for example direct communications with the mobile terminal such as electronic mail, SMS/MMS messages, applications operating locally on the mobile terminal, or advertisements on a search engine webpage. Broker-initiated potential transactions can also include direct communications to the mobile terminal such as electronic mail, SMS/MMS messages, applications operating locally on the mobile terminal, or advertisements on a search engine webpage. Additionally, broker-initiated potential transactions can include search engine optimization in response to particular Internet searches, direct communications of the type described above in response to a search engine search history of the mobile terminal, direct communications of the type described above in response to a location history of the mobile terminal, and/or direct communications of the type described above in response to elective information derived from the user of the mobile terminal, i.e. a user-generated user profile/preferences.

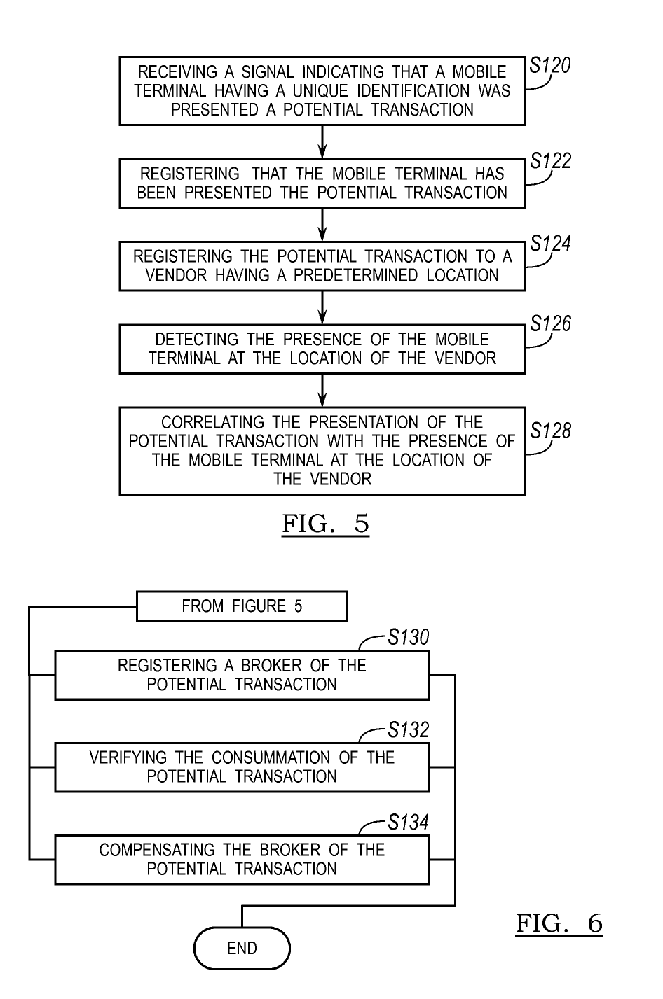

As shown in FIG. 5, a method according to a third preferred embodiment can include block S120, which recites receiving a signal indicating that a mobile terminal having a unique identification was presented a potential transaction. Block S120 functions to associate a unique identification, such as an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network, with a potential transaction associated with a vendor. Block S120 can be performed by any suitable system or apparatus, including a system of the type described herein, such as for example by the controller and/or one or more additional apparatuses or modules described above.

Block S122 of the method of the third preferred embodiment recites registering that the mobile terminal has been presented the potential transaction. Block S122 functions to record, memorialize, track, and/or confirm that the potential transaction has been associated with the mobile terminal. Block S122 can be performed by any suitable system or apparatus, including a system of the type described herein, such as for example one or more of the controller, the potential transaction database, the mobile terminal identification database and/or additional apparatuses or modules described above.

Block S124 of the method of the third preferred embodiment recites registering the potential transaction to a vendor having a predetermined location. Block S124 functions to record, memorialize, track, and/or confirm that the potential transaction has been associated with a vendor having a predetermined location, such as for example one or more finite locations. Block S124 can be performed by any suitable system or apparatus, including a system of the type described herein, such as for example one or more of the controller, the potential transaction database, the mobile terminal identification database and/or additional apparatuses or modules described above.

Block S126 of the method of the third preferred embodiment recites detecting the presence of the mobile terminal at the location of the vendor. Block S126 functions to confirm or verify that the mobile terminal, and therefore a user of the mobile terminal, is located or disposed at or near a physical location of the vendor. Block S126 further functions to confirm or verify that a party (the user of the mobile terminal) to the potential transaction is in the presence of the counter-party (the vendor) to the potential transaction. Block S126 can be performed by any suitable system or apparatus, including a system of the type described herein, such as for example one or more of the sensor array, the controller, the mobile terminal identification database and/or additional apparatuses or modules described above.

Block S128 of the method of the third preferred embodiment recites correlating the presentation of the potential transaction with the presence of the mobile terminal at the location of the vendor. Block S128 functions to record, confirm, memorialize and acknowledge that the mobile terminal, and therefore the user of the mobile terminal, is at or near a finite, physical location of the vendor in response to the presentation of the potential transaction on or at the mobile terminal. Block S128 can be performed by any suitable system or apparatus, including a system of the type described herein, such as for example one or more of the sensor array, the controller, the potential transaction database, the mobile terminal identification database and/or additional apparatuses or modules described above.

In one variation of the method of the third preferred embodiment, the predetermined location is a finite location. In another variation of the method of the third preferred embodiment, the finite location of the vendor can be within a larger finite location, such as for example a shopping mall or department store. Alternatively, the finite location of the vendor can include an aisle or portion of an aisle within a larger establishment, such as a shopping mall, department store, grocery store, so-called big box store, or any other establishment within which goods or services of multiple vendors are offered.

As shown in FIG. 6, another variation of the method of the third preferred embodiment can include block S130, which recites registering a broker of the potential transaction. Block S130 functions to record, memorialize, track, and/or confirm that the potential transaction has been associated with a broker. Block S130 can be performed by any suitable system or apparatus, including a system of the type described herein, such as for example one or more of the controller, the potential transaction database, the mobile terminal identification database and/or additional apparatuses or modules described above. In one alternative, the broker can include one of an Internet search engine service, a mobile terminal application service, an electronic coupon service, an Internet auction service, a barcode service, an SMS sales service, an MMS sales service, an electronic mail sales service, an Internet sales service or any suitable combination thereof.

Another variation of the method of the third preferred embodiment shown in FIG. 6 can include block S132, which recites verifying the consummation of the potential transaction. Block S132 functions to record, memorialize, confirm, and/or acknowledge that a user of the mobile terminal has completed, consummated or otherwise satisfied one or more conditions of the potential transaction. Block S132 can be performed by any suitable system or apparatus, including a system of the type described herein, such as for example one or more of the controller, the potential transaction database, the mobile terminal identification database and/or additional apparatuses or modules described above.

FIG. 6 also includes block S134, which is another variation of the method of the third preferred embodiment. Block S134 recites compensating the broker of the potential transaction. In one alternative, block S134 can include compensating the broker in response to a completed or consummated transaction between the vendor and the user of the mobile terminal. In such a manner, the broker of the potential transaction can be compensated in response to an exchange of value between the vendor and the user of the mobile terminal. Broker compensation can be derived from the vendor, the user of the mobile terminal, or an unrelated party. Alternatively, the broker compensation can be derived from the vendor in response to the vendor's receipt of compensation from the user of the mobile terminal, and the broker's compensation can be derived as a commission or percentage of completed or consummated transactions.

In another alternative of the method of the third preferred embodiment, block S134, which recites compensating the broker of the potential transaction, can include compensating the broker in response to a number of mobile terminals detected in the location of the vendor. In this alternative to the method of the second preferred embodiment, the broker can be compensated by driving traffic (users of mobile terminals) to the finite location of the vendor. The broker compensation can be derived on a fee-per-user basis measured over a time interval, or a fee-per-user basis measured for a particular event such as a sale or special offer. Additionally, the broker compensation can be a combination of a fee-per-user amount combined with a fee-per-completed transaction of the type described above, such that a broker can realize additional compensation for driving traffic to the vendor that results in actual revenues to the vendor.

As noted above, the broker of the potential transaction of the method of the third preferred embodiment can be a third party that is unrelated to the vendor or the user of the mobile terminal, such as for example: an Internet search engine service, a mobile terminal application service, an electronic coupon service, an Internet auction service, a barcode service, an SMS sales service, an MMS sales service, an electronic mail sales service, an Internet sales service or any combination thereof. Alternatively, the broker of the potential transaction can be an agent of the vendor, representative of the vendor, affiliate of the vendor, employee of the vendor, partner of the vendor, subsidiary of the vendor, the vendor itself, or any combination thereof. The broker can be a single entity or individual or a combination of multiple entities or individuals, and can be compensated by the vendor, the user of the mobile terminal, or any suitable combination thereof.

In another variation of the method of the third preferred embodiment, the unique identification of the mobile terminal can include a device identification code. Suitable device identification codes can include an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network. Suitable communication networks can include cellular phone mobile networks (including CDMA and GSM networks), WiFi networks, WiMax networks, LTE networks, Bluetooth networks, and any other RF wireless network to which a mobile terminal is connectable. A mobile terminal can have more than one unique identifier. As noted above, a typical smartphone can have both an IMEI and a MAC address and may be configured for connecting to the Internet via a cellular network and/or a WiFi network, in which case both unique identifiers can be associated with a single mobile terminal and therefore a single user of that mobile terminal. Accordingly, a user of the mobile terminal can view a potential transaction (i.e., conduct an Internet search) using a WiFi connected mobile terminal, and then arrive at a vendor location and be identified in response to an IMEI or other non-WiFi identifier. Suitable means for categorizing and correlating multiple unique identifiers to a single mobile terminal can be accomplished for example by a controller or a mobile terminal identification database of the type described herein.

In another variation of the method of the third preferred embodiment, block S126 can further include receiving a communication channel signal comprising the device identification code at the location of the vendor. As noted above, the device identification code can include an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network. The communication channel signal can be transmitted by the mobile terminal at the location of the vendor on its own accord, or in response to an external stimulus, such as the receipt of a signal by the mobile terminal at the finite location of the vendor. In one alternative, receiving a communication channel signal can include receiving, at a sensor array of the type described above, the communication channel signal.

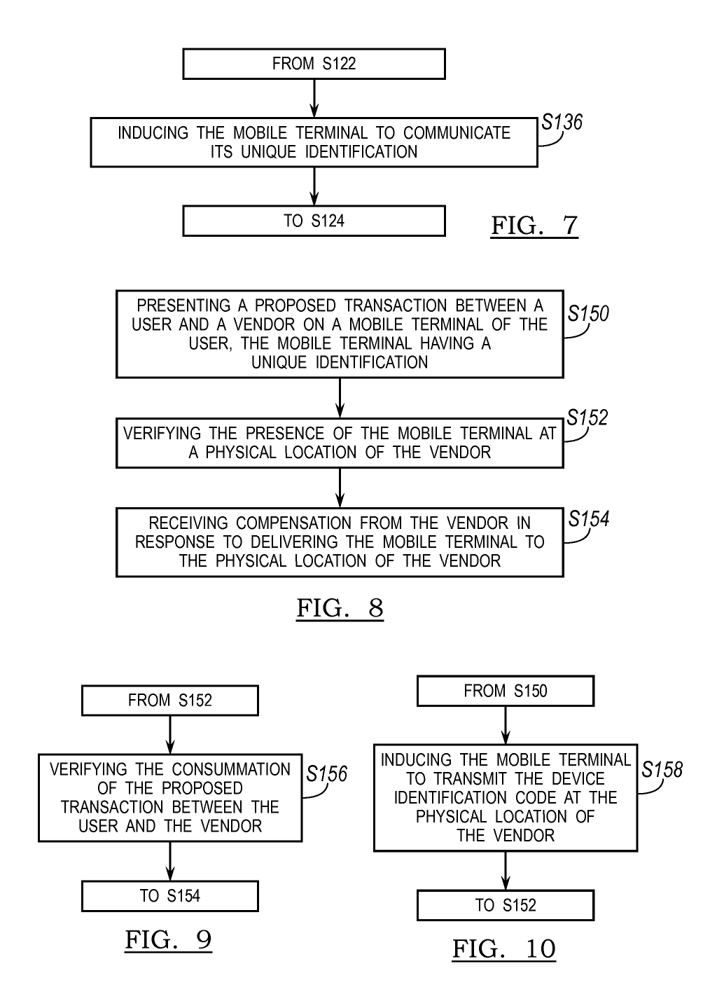

As shown in FIG. 7, another variation of the method of the third preferred embodiment can include block S136, which recites inducing the mobile terminal to communicate its unique identification. As noted above, a unique identification can include a suitable code, number, or identifier that is usable by a mobile terminal in identifying itself to a communication network, such as for example a MAC address, an IMEI, an IMSI, a TMSI and any suitable combination thereof.

In another variation of the method of the third preferred embodiment, inducing the unique identification of the mobile terminal can include inducing a communication channel signal from the mobile terminal such that the mobile terminal transmits the device identification code, such as for example a MAC address, an IMEI, an IMSI, a TMSI and any suitable combination thereof. In one alternative, inducing a communication channel signal can include transmitting a control channel signal within the location of the vendor, wherein the location of the vendor can include a finite location as described herein.

In another variation of the method of the third preferred embodiment, transmitting a control channel signal can include causing a pseudo-station to transmit a control channel signal in a predetermined frequency for a predetermined duration. Control of the pseudo-station can be accomplished by a controller and/or pseudo-station of the type described above. The pseudo-station functions to transmit a control channel signal in order to induce the communication channel signal from the mobile terminal, which in turn identifies the mobile terminal to the sensor array and the controller. The pseudo-station of the method of the third preferred embodiment functions as at least one portion of a base station of the type used in mobile communications, i.e. mobile telephony networks such as GSM or CDMA networks, WiFi networks, WiMax networks, LTE networks, Bluetooth networks, and the like. Alternatively, the pseudo-station of the method of the third preferred embodiment can function only to interrogate and initiate communications with a mobile terminal on a control channel.

As noted in this variation of the method of the third preferred embodiment, the pseudo-station can be configured to transmit a control channel signal at a predetermined frequency for a predetermined duration. The predetermined frequency at which the pseudo-station transmits the control channel signal can include a frequency range correlated to a selected type of mobile terminal. As a non-limiting example, the pseudo-station of the method of the third preferred embodiment can transmit a control channel signal on or in a frequency range dedicated to cellular phone mobile terminals (including portions of spectrum dedicated to different types of network protocols such as CDMA and GSM), WiFi enabled mobile terminals, WiMax enabled mobile terminals, LTE enabled mobile terminals, Bluetooth enabled mobile terminals, and the like. Alternatively, the pseudo-station of the method of the third preferred embodiment can be further adapted to transmit the control channel signal on one or more channels within the frequency range. The pseudo-station of the method of the third preferred embodiment can be configured to transmit the control channel signal on one, multiple, or all channels within a particular band of frequencies in order to induce communication with various types of mobile terminals.

Additionally, the pseudo-station of the method of the third preferred embodiment can be configured to transmit the control channel signal for a predetermined duration. In one example configuration, the predetermined duration can range between 1 microsecond and 10 seconds. The predetermined duration can be fixed or dynamic, or it can vary between predetermined frequencies and/or channels within the predetermined frequencies. Alternatively, the predetermined duration can be determined, either fixedly or dynamically, as inversely proportional to an activity level within the vendor finite location. That is, a shorter predetermined duration can correspond with a higher activity level within the vendor location. As an example, for a vendor finite location having relatively few users and/or relatively stationary of mobile terminals, such as a movie theatre, the predetermined duration can be longer. Conversely, for a vendor finite location having relatively many users and/or mobile users of mobile terminals, such as a subway entrance, the predetermined duration can be shorter. A vendor finite location can also have different time periods such as rush hour, holiday shopping/travel, seasons, or other factors that can result in an increase or decrease in the predetermined duration for which the pseudo-station transmits the control channel signal.

In another variation of the method of the third preferred embodiment, the pseudo-station and a sensor of a sensor array can be configured as an integrated cellular base station, such that the pseudo-station and the sensor can function in a unified manner to transmit a control channel signal and to receive one or more communication channel signals. Furthermore, the integrated pseudo-station and sensor can be configured for forward transmission of communication channel signals to the one or more mobile terminals in its network. The pseudo-station and sensor of the present variation of the first preferred embodiment can be configured as any one of a microcell, picocell or femtocell, depending upon the application requirements and the configuration of the vendor finite location.

As shown in FIG. 8, a method according to a fourth preferred embodiment can include block S150, which recites presenting a proposed transaction between a user and a vendor on a mobile terminal of the user, the mobile terminal having a unique identification. Block S150 functions to initiate a proposed transaction between the user of the mobile terminal, which is uniquely identifiable, and the vendor. Block S150 can be performed or initiated by the user, the vendor, or a broker. The presentation of the potential transaction can manifest at the mobile terminal in any number of ways, including for example: as the result of an Internet search conducted on the mobile terminal, the browsing of a webpage associated with the vendor at the mobile terminal, the use of an application associated with the mobile terminal, the receipt of a coupon from a coupon service at the mobile terminal, the scanning of a barcode by the mobile terminal, receipt of an SMS or MMS message at the mobile terminal, receipt of an email message at the mobile terminal, or receipt of a voice or other data message at the mobile terminal. In one alternative, the unique identifications of the mobile terminal can include, but are not limited to: an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network.

As shown in FIG. 8, the method of the fourth preferred embodiment can further include block S152, which recites verifying the presence of the mobile terminal at a physical, finite location of the vendor. Block S152 functions to register, acknowledge, record and/or memorialize that the uniquely identifiable mobile terminal is at or near a physical location of the vendor. A controller, a sensor array, and/or a mobile terminal identification database of the type described herein can perform one or more functions shown in block S152. In one alternative of the method of the fourth preferred embodiment, the physical location of the vendor can be a finite location. Alternatively, the physical location of the vendor can include a finite location within a larger finite location, such as for example a shopping mall or department store. Alternatively, the physical location of the vendor can include an aisle or portion of an aisle within a larger establishment, such as a shopping mall, department store, grocery store, so-called big box store, or any other establishment within which goods or services of multiple vendors are offered.

As shown in FIG. 8, the method of the fourth preferred embodiment can further include block S154, which recites receiving compensation from the vendor in response to delivering the mobile terminal to the physical location of the vendor. Block S154 functions to provide value to a broker or other third party for the presentation of the proposed transaction on the mobile terminal of the user resulting in the user visiting a physical location of the vendor. In one alternative, the compensation is receivable in response to delivery of one or more mobile terminals to the vendor location. In another alternative, the compensation is receivable in response to a gross amount of goods or services purchased from the vendor by a user of a mobile terminal, wherein such goods or services are not necessarily related to the proposed transaction.

As shown in FIG. 9, a variation of the method of the fourth preferred embodiment can further include block S156, which recites verifying the consummation of the proposed transaction between the user and the vendor. Block S156 functions to record, memorialize, confirm, and/or acknowledge that a user of the mobile terminal has completed, consummated or otherwise satisfied one or more conditions of the potential transaction. Block S156 can be performed by any suitable system or apparatus, including a system of the type described herein, such as for example one or more of the controller, the potential transaction database, the mobile terminal identification database and/or additional apparatuses or modules described above. In the variation of the method of the fourth preferred embodiment, a broker or other third party can receive compensation in response to verification of the consummation of the proposed transaction, in lieu of or in addition to other values attributable to the recipient of the vendor's compensation noted above.

In another variation of the method of the fourth preferred embodiment, block S152 can include receiving a communication from the mobile terminal of the unique identification. As noted above, unique identifications of the mobile terminal can include, but are not limited to: an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network. Receipt of the communication from the mobile terminal can be performed by a sensor array, mobile terminal identification database and/or controller of the type described herein. In one alternative, the device identification code can be transmittable in a communication channel of the mobile terminal. Alternatively, the device identification code can be stored on a mobile terminal identification database of the type described above, such that the mobile terminal can identify itself through another type of communication layer or channel directly, and still be identified according to its device identification code at or on the controller and/or mobile terminal identification database.

As shown in FIG. 10, another variation of the method of the fourth preferred embodiment can include block S158, which recites inducing the mobile terminal to transmit the device identification code at the physical location of the vendor. In one alternative of the variation of the method of the fourth preferred embodiment, inducing the unique identification of the mobile terminal can include inducing a signal from the mobile terminal such that the mobile terminal transmits the device identification code. As an example, inducement of a communication channel signal from the mobile terminal can result in the transmission of its unique identification, such as for example an IP address based on a static and/or dynamic number, character or combination such as a MAC address, an IMEI, an IMSI, a TMSI, a Bluetooth device address, a separate identifier associated with an application, software, firmware or operating system of a mobile device, or any other suitable code, number, or identifier that is usable by a mobile terminal in identifying itself to a communication network. In another alternative, inducing the mobile terminal to transmit the device identification code can include can include transmitting a control channel signal within the location of the vendor, in response to which the mobile terminal will transmit a communication channel signal including its device identification code.

In the foregoing variations of the method of the fourth preferred embodiment, the associated functions can be performed directly or indirectly by causing a pseudo-station to transmit a control channel signal, which can be accomplished by a controller and/or pseudo-station of the type described above. The pseudo-station functions to transmit a control channel signal in order to induce the communication channel signal from the mobile terminal, which in turn identifies the mobile terminal to the sensor array and the controller. The pseudo-station of the method of the fourth preferred embodiment functions as at least one portion of a base station of the type used in mobile communications, i.e. mobile telephony networks such as GSM or CDMA networks, WiFi networks, WiMax networks, LTE networks, Bluetooth networks, and the like. Alternatively, the pseudo-station of the method of the fourth preferred embodiment can function only to interrogate and initiate communications with a mobile terminal on a control channel.

The flowcharts and block diagrams in the Figures illustrate the architecture, functionality and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular terms “a”, “an” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements and specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The preferred embodiments were chosen and described in order to best explain the principles of the invention and the practical applications, and to enable others of ordinary skill in the art to understand the invention for various embodiments with various modifications as are suited to the particular use contemplated.

What is claimed is:

1. A method comprising:
correlating a potential transaction with a unique identification of a mobile terminal, the potential transaction comprising a vendor and a user of the mobile terminal;
determining that the mobile terminal is in a finite location of the vendor; and
compensating a broker of the potential transaction.

2. The method of claim 1, wherein the finite location of the vendor comprises an indoor location.

3. The method of claim 1, further comprising verifying a completion of the potential transaction between the vendor and the user of the mobile terminal.

4. The method of claim 1, wherein the unique identification of the mobile terminal comprises a device identification code.

5. The method of claim 4, wherein determining that the mobile terminal is in the finite location of the vendor comprises receiving a communication channel signal comprising the device identification code at the finite location of the vendor.

6. The method of claim 5, further comprising inducing a communication channel signal from the mobile terminal such that the mobile terminal transmits the device identification code.

7. The method of claim 6, wherein inducing a communication channel signal comprises transmitting a control channel signal within the finite location of the vendor.

8. The method of claim 1, wherein compensating the broker comprises compensating the broker in response to a completed transaction between the vendor and the user of the mobile terminal.

9. The method of claim 1, wherein compensating the broker comprises compensating the broker in response to a number of mobile terminals detected in the location of the vendor.

10. The method of claim 1, wherein the potential transaction is a user-initiated event.

11. The method of claim 1, wherein the potential transaction is a broker-initiated event.

12. An apparatus comprising:
a controller connected to a sensor array disposable in a finite location of a vendor and further connected to a mobile terminal defining a unique identification, the controller adapted to associate a potential transaction with the unique identification of the mobile terminal, and further adapted to determine a presence of the mobile terminal at the finite location of the vendor in response to receipt of the communication channel signal at the sensor array from the mobile terminal, the communication channel signal comprising the unique identification of the mobile terminal.

13. The apparatus of claim 12 wherein the sensor array comprises a single sensor.

14. The apparatus of claim 12, wherein the sensor array comprises at least two sensors.

15. The apparatus of claim 12, wherein the controller is further connected to a pseudo-station disposable in the finite location of the vendor, the pseudo-station adapted to transmit a control channel signal in order to induce the communication channel signal from the mobile terminal.

16. A computer program product comprising:
a computer readable storage medium having computer readable program code embodied therewith, the computer readable program code comprising:
computer readable program code to correlate a potential transaction with a unique identification of a mobile terminal, wherein the potential transaction can include a vendor and a user of the mobile terminal;
computer readable program code to determine that the mobile terminal is an finite location of the vendor; and
computer readable program code to compensate a broker of the potential transaction.

17. The computer program product of claim 16, wherein the finite location of the vendor comprises an indoor location.

18. The computer program product of claim 16, further comprising computer readable program code to verify a completion of the potential transaction between the vendor and the user of the mobile terminal.

19. The computer program product of claim 16, wherein the unique identification of the mobile terminal comprises a device identification code.

20. The computer program product of claim 19, further comprising computer readable program code to receive a communication channel signal comprising the device identification code at the finite location of the vendor.

21. The computer program product of claim 20, further comprising computer readable program code to induce a communication channel signal from the mobile terminal such that the mobile terminal transmits the device identification code.

22. The computer program product of claim 21, wherein computer readable program code to induce a communication channel signal comprises computer readable program code to transmit a control channel signal within the finite location of the vendor.

23. The computer program product of claim 16, wherein the potential transaction is a user-initiated event.

24. The computer program product of claim 16, wherein the potential transaction is a broker-initiated event.

25. A method comprising:
receiving a signal indicating that a mobile terminal having a unique identification was presented a potential transaction;
registering that the mobile terminal has been presented the potential transaction;
registering the potential transaction to a vendor having a predetermined location;
detecting the presence of the mobile terminal at the location of the vendor;
correlating the presentation of the potential transaction with the presence of the mobile terminal at the location of the vendor.

26. The method of claim 25, wherein the predetermined location is a finite location.

27. The method of claim 25, further comprising registering a broker of the potential transaction.

28. The method of claim 27, wherein the broker comprises one of an Internet search engine service, a mobile terminal application service, an electronic coupon service, an Internet auction service, a barcode service, an SMS sales service, an MMS sales service, an electronic mail sales service, or an Internet sales service.

29. The method of claim 27, further comprising verifying the consummation of the potential transaction.

30. The method of claim 29, further comprising compensating the broker of the potential transaction.

31. The method of claim 25, wherein the unique identification of the mobile terminal comprises a device identification code.

32. The method of claim 25, wherein detecting the presence of the mobile terminal at the vendor comprises receiving a communication channel signal comprising the device identification code at the location of the vendor.

33. The method of claim 25, further comprising inducing the mobile terminal to communicate its unique identification.

34. The method of claim 33, wherein inducing the mobile terminal to communicate its unique identification comprises inducing a communication channel signal from the mobile terminal such that the mobile terminal transmits the device identification code.

35. The method of claim 34, wherein inducing a communication channel signal comprises transmitting a control channel signal within the location of the vendor.

36. The method of claim 35, wherein transmitting a control channel signal comprises causing a pseudo-station to transmit a control channel signal in a predetermined frequency for a predetermined duration.

37. A method comprising:
presenting a proposed transaction between a user and a vendor on a mobile terminal of the user, the mobile terminal having a unique identification;
verifying the presence of the mobile terminal at a physical location of the vendor; and
receiving compensation from the vendor in response to delivering the mobile terminal to the physical location of the vendor.

38. The method of claim 37, further comprising verifying the consummation of the proposed transaction between the user and the vendor.

39. The method of claim 37, wherein verifying the presence of the mobile terminal at the physical location comprises receiving a communication from the mobile terminal of the unique identification.

40. The method of claim 39, wherein the unique identification comprises a device identification code transmittable in a communication channel of the mobile terminal.

41. The method of claim 40, further comprising inducing the mobile terminal to transmit the device identification code at the physical location of the vendor.

42. The method of claim 41, wherein inducing the mobile terminal to transmit the identification code comprises transmitting a control channel signal to the mobile terminal in the physical location of the vendor such that the mobile terminal responds with the device identification code.

43. The method of claim 37, wherein the physical location of the vendor comprises a finite location.
